(19) United States
(12) Patent Application Publication
(10) Pub. No.: US 2005/0211026 A1
(43) Pub. Date: Sep. 29, 2005

(54) Head of a power ratchet tool

(76) Inventor: Ming-Kun Cheng, Miaoli Hsien (TW)

Correspondence Address: HERSHKOVITZ & ASSOCIATES, 1725 I STREET NW, SUITE 300, WASHINGTON, DC, 20006, US

(21) Appl. No.: 10/809,487

(22) Filed: Mar. 26, 2004

(51) Int. Cl. B25B 13/46

(52) U.S. Cl. 81/57.39

(57) ABSTRACT

A head has a head portion and a connecting portion. The head portion is adapted for receiving the ratchet mechanism and has an inner space, a mouth, two side walls and an opening. The inner space is defined between the top and the bottom to receive the ratchet mechanism of the power ratchet tool. The mouth is defined in the front end and communicates with the inner space to define the side walls between the top and the bottom. The opening is defined in the bottom and communicates with the inner space for a stub of the ratchet mechanism extending out from the opening. The connecting portion is connected to the rear end of the head portion for being attached to the handle of the power ratchet tool. Accordingly, a head with an enhanced structural strength is provided.

### BACKGROUND OF THE INVENTION

1. Field of the Invention

The present invention relates to a head, and more particularly to a head of a power ratchet tool and that has a reinforced structure with a capability of bearing a large torque to keep the head from deformation while the power ratchet tool is in operation.

2. Description of Related Art

With reference to FIG. 4, a conventional power ratchet tool (60), such as pneumatic ratchet tool or electrical ratchet tool comprises a handle (62), a head (66) and a ratchet mechanism (64). The head (66) is mounted on one end of the handle (62). The ratchet mechanism (64) is mounted in the handle (62) and the head (66) and is connected to a power source through a hose. The ratchet mechanism (64) has a stub (642) extending out from the head (66) and adapted for fitting with a sleeve. With such a power ratchet tool (60), the sleeve will be driven to rotate by the transmission of the ratchet mechanism (64) to tighten or loosen a fastener with a torque provided by the ratchet mechanism.

To assemble the ratchet mechanism (64) into the head (62), a mouth (662) and through holes (664) are defined in the head (66). However, the head must bear a large torque provided by the ratchet mechanism, but the arrangements of the mouth (662) and through holes (664) will reduce the structural strength of the head (66). The head (66) is easily damaged or deformed, as shown in FIG. 5 when the large torque occurs during the operation of the power ratchet tool (60), such that the useful life of the conventional power ratchet tool (60) is decreased.

U.S. Pat. No. 4,201,099, entitled “Hydraulic Wrench” to Junkers shows a housing portion with a mouth covered with a metal cover. To assemble a ratchet mechanism into the head, a mouth with a large width is necessary. The housing portion of the '099 Patent is also not durable due to the arrangement of the mouth. In addition, with the arrangement of the mouth having a large width, a dust cover is a necessary element to keep any dust or dirt from entering into head from the mouth. Therefore, the structure of the head is complex, and the dust cover cannot provide any assistance to the structural strength of the head. U.S. Pat. No. 4,086,829, entitled “Speed Handle Ratchet” to Hedging shows a ratchet that has a head with a side portion. The side portion is an integral structure surrounding the head. However, the ratchet of the '829 Patent is a manual tool, not a power tool. The structure of the head of the '829 Patent cannot be applied to a power tool. U.S. Pat. No. 6,330,842, entitled “Compact Head Power Driven Ratchet Tool” to Brun shows a ratchet tool that has a head with a sidewall. The sidewall is an integral structure surrounding the head. However, the ratchet of the '842 Patent is a manual tool, not a power tool. The structure of the head of the '842 Patent cannot be applied to a power tool. In addition, to assemble ratchet mechanism into the head with integrally surrounding sidewalls, a through hole with a large area must be defined respective in the top and bottom of the head. The structural strength of the head is reduced due to the arrangement of the through holes. In addition, two dust covers are attached to the head to close the through hole and are necessary, but the dust covers cannot provide any assistance to the structural strength of the head.

To overcome the shortcomings, the present invention tends to provide a head of a power ratchet tool to mitigate or obviate the aforementioned problems.

### SUMMARY OF THE INVENTION

The main objective of the invention is to provide a head for a power ratchet tool and that has an enhanced structural strength. The head has a head portion and a connecting portion. The head portion is adapted for receiving the ratchet mechanism and has a front end, a rear end, a top, a bottom, a periphery, an inner space, a mouth, two side walls and an opening. The inner space is defined between the top and the bottom to receive the ratchet mechanism of the power ratchet tool. The mouth is defined in the front end and communicates with the inner space to define the side walls between the top and the bottom. The opening is defined in the bottom and communicates with the inner space for a stub of the ratchet mechanism extending out from the opening. The connecting portion is connected to the rear end of the head portion for being attached to the handle of the power ratchet tool. With the arrangement of the side walls, the structural strength of the head is improved, and the useful life of the head is prolonged.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a head for a power ratchet tool in accordance with the present invention;

FIG. 2 is an exploded perspective view of the head in FIG. 1;

FIG. 3 is a side plan view in partial cross section of the head in FIG. 1;

FIG. 4 is a perspective view of a conventional power ratchet tool with a conventional head in accordance with the prior art; and

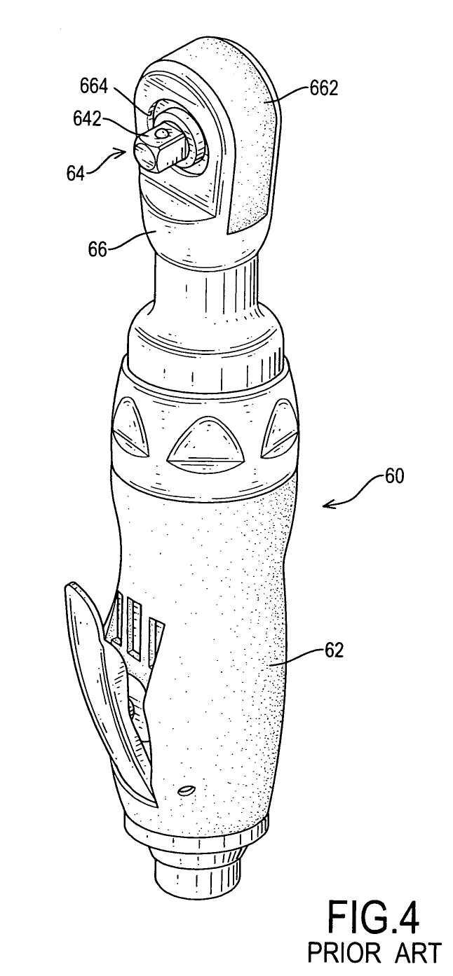

FIG. 5 is a perspective view of a deformed conventional head in FIG. 4.

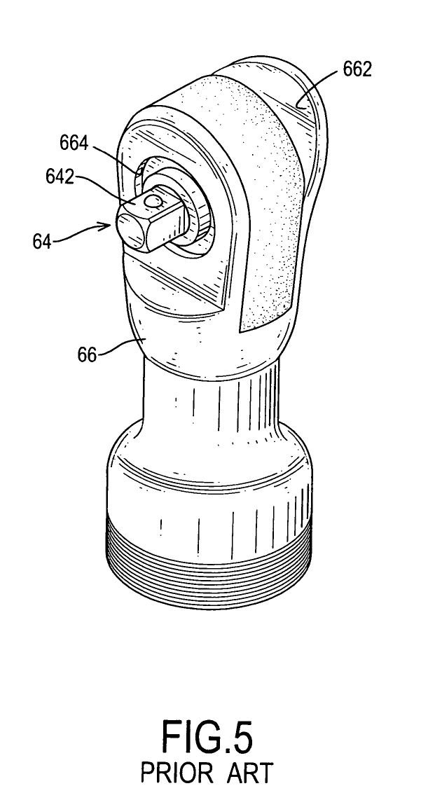

### DETAILED DESCRIPTION OF PREFFERRED EMBODIMENT

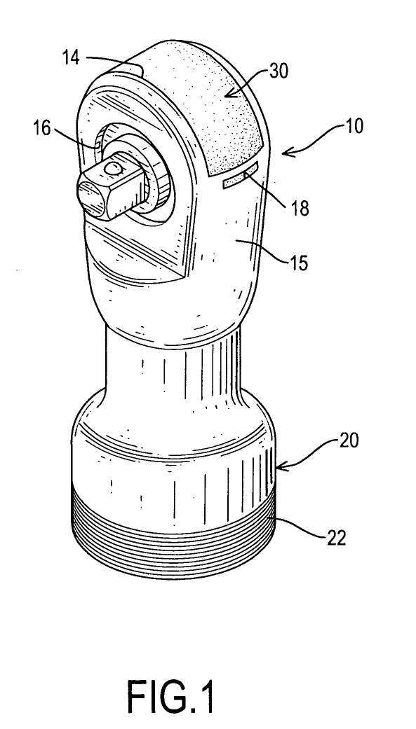

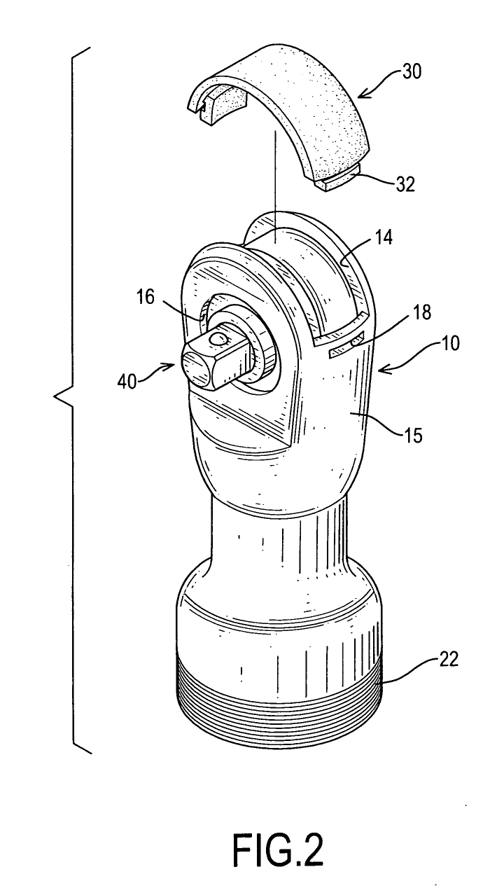

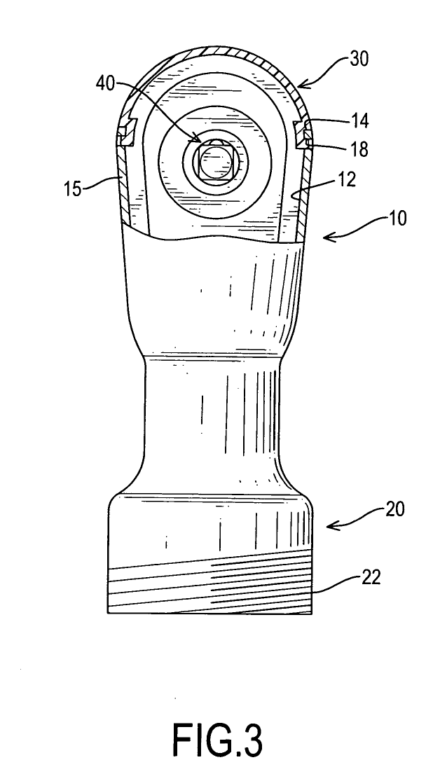

With reference to FIGS. 1 to 3, a head for a power ratchet tool in accordance with the present invention comprises a head portion (10), a connecting portion (20) and an optional dust cover (30). The head portion (10) and the connecting portion (20) can be integrally formed together to a single piece. In an alternative embodiment, the head portion (10) and the connecting portion (20) can be two separate parts and be combined together by means of screwing, welding or any possible way in the art. The head portion (10) has a front end, a rear end, a top, a bottom, a periphery, an inner space (12), a mouth (14), two side walls (15), an opening (16) and two optional slots (18). The inner space (12) is defined in the head portion (10) between the top and the bottom to receive a ratchet mechanism (40) of the power ratchet tool. The mouth (14) is defined in the front end and communicates with the inner space (12) to define the side walls (15) between the top and the bottom. In a preferable embodiment, the mouth (14) has a length smaller than half of the length of the periphery of the head portion (10). The opening (16) is defined in the bottom and communicates with the inner space (12) for a stub of the ratchet mechanism (40) extending out from the opening (16). The optional slots (18) are defined respectively in the side walls (15) and are near the mouth (14).

The connecting portion (20) is connected to the rear end of the head portion (10) and is adapted for being attached to a handle of the power ratchet tool. The connecting portion (20) optionally has an outer thread (22) for screwing with the handle of the ratchet tool.

The optional dust cover (30) is attached to the head portion (10) to close the mouth (14) in the head portion (10). In an optional embodiment, the front end of the head portion (10) is curved to make the mouth (14) curved, and the dust cover (30) is also curved to fit with the curved mouth (14) in the front end of the head portion (10). The dust cover (30) has two ends and two hooks (32) protruding respectively from the ends to engage respectively with the slots (18) defined in the side walls (15), such that the dust cover (30) is securely attached to the head portion (10) with the engagements of the hooks (32) and slots (18).

With such a head, because two the side walls (15) are formed on the head portion (10) of the head, the structural strength of the head will be enhanced. With the reinforced structure of the head, the head can bear a large torque provided by the ratchet mechanism while the power ratchet tool is in operation. The head is not easily deformed by the torque occurring during the operation of the power ratchet tool, so the useful life of the head and the ratchet mechanism is prolonged. In addition, the head in accordance with the present invention can fit with a power ratchet tool with a large output torque, the use of the head is versatile.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A head of a power ratchet tool having a handle and a ratchet mechanism with a stub, the head comprising:
a head portion for receiving the ratchet mechanism and having
a front end;
a rear end;
a top;
a bottom;
a periphery;
an inner space defined between the top and the bottom to receive the ratchet mechanism of the power ratchet tool;
a mouth defined in the front end and communicating with the inner space to form two side walls between the top and the bottom and extending from the rear end toward the front end; and
an opening defined in the bottom and communicating with the inner space for the stub of the ratchet mechanism extending out from the opening; and
a connecting portion connected to the rear end of the head portion for being attached to the handle of the power ratchet tool.

2. The head as claimed in claim 1, wherein the mouth has a length smaller than half of the length of the periphery of the head portion.
